(19) United States
(12) Patent Application Publication
(10) Pub. No.: US 2013/0075573 A1
(43) Pub. Date: Mar. 28, 2013

(54) SNOW GUN MOUNTING APPARATUS

(71) Applicant: Brian Marston, Jericho, VT (US)

(72) Inventor: Brian Marston, Jericho, VT (US)

(21) Appl. No.: 13/244,461

(22) Filed: Sep. 24, 2011

(51) Int. Cl. F16M 11/04

(52) U.S. Cl. 248/674

(57) ABSTRACT

The present invention is a snow gun mounting apparatus to mount a snow gun that includes a snow gun holder with a pair of vertical protrusions with an aperture disposed on each vertical protrusion, a metal front leg with a pair of legs with the snow gun holder welded on front metal leg, a pair of ball wheels that are welded to the ends of the metal front leg and a rear support leg that extends from the back of the snow gun holder and the metal front leg. The apparatus also includes a plurality of adjustment apertures that are disposed on each rear support leg, a pair of friction brakes that are attached to each rear supports leg and a pair of powder stoppers that are attached to each rear supports leg.

### TECHNICAL FIELD & BACKGROUND

Snowmaker crews have the laborious task of moving snow guns to different locations, which can become tiring and extremely taxing on the body. Currently there are limited alternatives to the sleds, tripods, and the manual method of moving snow guns that can avoid the hassles of excessive time consumption, discomfort and muscle aches.

The present invention generally relates to a mounting apparatus. More specifically, the invention is a snow gun mounting apparatus.

It is an object of the invention to provide a snow gun mounting apparatus that simplifies the process of transporting a snow gun.

It is an object of the invention to provide a snow gun mounting apparatus that is relatively easier to move and transport a snow gun than a conventional snow gun mounting apparatus.

It is an object of the invention to provide a snow gun mounting apparatus that provides relatively more stability while moving and transporting a snow gun than a conventional snow gun mounting apparatus.

What is really needed is a snow gun mounting apparatus that simplifies the process of transporting a snow gun that is relatively easier to move and transport a snow gun than a conventional snow gun mounting apparatus and that provides relatively more stability while moving and transporting a snow gun than a conventional snow gun mounting apparatus.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a snow gun mounting apparatus, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

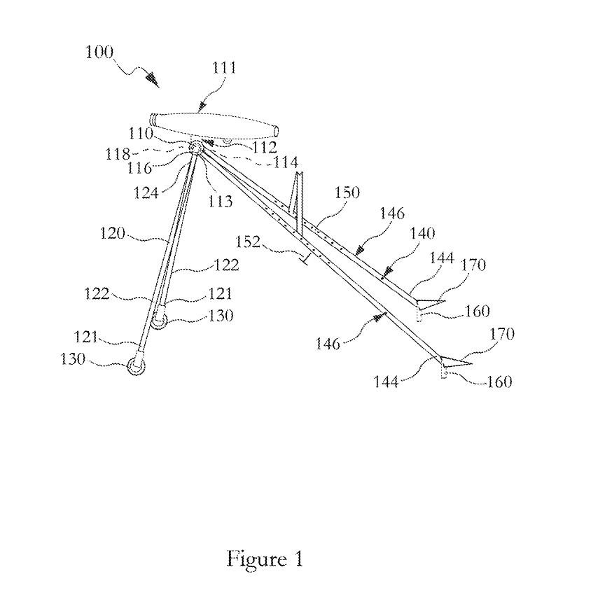

FIG. 1 illustrates a side perspective view of a snow gun mounting apparatus 100, in accordance with one embodiment of the present invention.

The snow gun mounting apparatus 100 includes a snow gun holder 110, a metal front leg 120, a pair of ball wheels 130, a rear support leg 140, a plurality of adjustment apertures 150, a pair of friction brakes 160 and a pair of powder stoppers 170.

The snow gun holder 110 includes a pair of vertical protrusions 112 with an aperture 114 disposed on an end 113 of the vertical protrusion 112. The apertures 114 accommodate a Grade 8 bolt 116 that is placed through the apertures 114 and is secured by a nut 118. The bolt 116 and nut 118 can also be any suitable grade of bolt 116 that can accommodate the apertures 114. The vertical protrusions 112 are welded to the snow gun mounting apparatus 100. The snow gun holder 110 is designed to secure a high pressure snow gun 111 with a plurality of relatively heavy and durable components. The metal front leg 120 has a v-shape with a pair of legs 122 each with an end 121 that are attached at a top 124 of the metal front leg 120. The snow gun holder 110 is specifically disposed on and welded to the top 124 of the front leg 120 as well. The pair of ball wheels 130 is attached on the ends 121 of the pair of legs 122. The pair of ball wheels 130 is a ball ski type of wheel that is welded to the ends 121 and is approximately in the range of 2 to 3 inches in radius. Other suitable types of ball wheels 130 and suitable dimensions can also be utilized with the snow gun mounting apparatus 100.

The rear support leg 140 is extended from the back of the snow gun holder 110 and the metal front leg 120. The rear support leg 140 includes a top 142 and two ends 144 and also has a v-shape with a pair of legs 146 that are attached at the top 142 of the rear support leg 140. The adjustment apertures 150 are disposed on the rear support legs 140 to adjust and set one of a plurality of predetermined lengths of the pair of legs 146. A lock pin 152 is inserted into the adjustment apertures 150 at a desired predetermined length to secure the rear support leg 140 in place at the desired predetermined length. Any suitable type of pin can be utilized to secure the rear support leg 140 in place at the desired predetermined length. The friction brakes 160 are attached to each end 144 of the legs 146 to secure the snow gun mounting apparatus 100 to a surface such as a ground surface where the snow gun mounting apparatus 100 is physically on. The powder stoppers 170 are also attached to each end 144 of the legs 146 adjacent to the friction brakes 160 to prevent the ends 144 from sinking into a relatively high amount of powder snow.

The snow gun mounting apparatus simplifies the process of transporting a snow gun that is relatively easier to move and transport than a conventional snow gun mounting apparatus and that provides relatively more stability while moving and transporting a snow gun than a conventional snow gun mounting apparatus. The snow gun is typically a high pressure snow gun although other types of snow guns can be utilized in combination with the snow gun mounting apparatus. The snow gun mounting apparatus is made of relatively strong but lightweight aluminum but can be made of other suitable materials as well. The snow gun mounting apparatus is approximately 3.5 feet in height, 3 feet in width, 5 feet in length and weighs approximately 30 pounds.

The snow gun mounting apparatus combines the collapsible benefits of a tripod and the stable sturdiness of a sled in order to expedite the process of transporting a snow gun. When using the snow gun mounting apparatus, a snowmaker is better able to move a running, high-pressured snow gun because of the increased comfort, balance, and control that the snow gun mounting apparatus can provide. The snow gun mounting apparatus is made of lightweight aluminum tubing, has the shape of an upside down U, and has a height of approximately 3.5 feet. The snow gun mounting apparatus is structured in a way so that snowmakers can maintain sturdiness under pressure and drag the apparatus as needed or desired. The snow gun mounting apparatus features all-terrain maneuverability and a compact frame in order to meet various storage needs. The snow gun mounting apparatus can be shipped in one piece or can be shipped in three pieces that are easily installed, all of which are colored in a safety yellow color.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A snow gun mounting apparatus to mount a snow gun, comprising:
a snow gun holder with a back that includes a pair of vertical protrusions with an end with an aperture disposed on each said end of said vertical protrusion;
a metal front leg with a top and a v-shape that includes a pair of legs with an end that are attached at said top of metal front leg with said snow gun holder welded on said top of front metal leg;
a pair of ball wheels that are welded to said ends of said metal front leg;
a rear support leg with a v-shape, a top, two ends and a pair of legs that extends from said back of said snow gun holder and said metal front leg;
a plurality of adjustment apertures that are disposed on each said rear support leg to adjust and set one of a plurality of predetermined lengths of said pair of legs of said rear support leg;
a pair of friction brakes that are attached to each said end of said rear supports legs to secure said snow gun mounting apparatus to a surface; and
a pair of powder stoppers that are attached to each said end of said rear supports legs adjacent to said friction brakes to prevent said ends of said rear supports legs from sinking into a high amount of powder snow.

2. The apparatus according to claim 1, wherein said apertures accommodate a bolt that is placed through said apertures.

3. The apparatus according to claim 1, wherein said bolt is secured by a nut to secure said snow gun holder to said snow gun mounting apparatus.

4. The apparatus according to claim 1, wherein said ball wheel is a ball ski type wheel.

5. The apparatus according to claim 1, wherein a lock pin is inserted into one of said adjustment apertures at a desired predetermined length to secure said rear support leg in place.

6. The apparatus according to claim 1, wherein said surface is a ground surface where said snow gun mounting apparatus on.

7. The apparatus according to claim 1, wherein said snow gun is a high pressure snow gun.

8. A heavy duty aluminum snow gun mounting apparatus to mount a high pressure snow gun, comprising:
a snow gun holder with a back that includes a pair of vertical protrusions with an end with an aperture disposed on each said end of said vertical protrusion, wherein said apertures accommodate a bolt that is placed through said apertures;
a metal front leg with a top and a v-shape that includes a pair of legs with an end that are attached at said top of metal front leg with said snow gun holder welded on said top of front metal leg;
a pair of ball wheels that are welded to said ends of said metal front leg;
a rear support leg with a v-shape, a top, two ends and a pair of legs that extends from said back of said snow gun holder and said metal front leg;
a plurality of adjustment apertures that are disposed on each said rear support leg to adjust and set one of a plurality of predetermined lengths of said pair of legs of said rear support leg;
a pair of friction brakes that are attached to each said end of said rear supports legs to secure said snow gun mounting apparatus to a ground surface; and
a pair of powder stoppers that are attached to each said end of said rear supports legs adjacent to said friction brakes to prevent said ends of said rear supports legs from sinking into a high amount of powder snow.

9. The apparatus according to claim 8, wherein said bolt is secured by a nut to secure said snow gun holder to said snow gun mounting apparatus.

10. The apparatus according to claim 9, wherein said nut is a Grade 8 bolt.

11. The apparatus according to claim 8, wherein said ball wheel is a ball ski type wheel.

12. The apparatus according to claim 11, wherein said ball wheels are approximately in the range of 2 to 3 inches in radius.

13. The apparatus according to claim 8, wherein a lock pin is inserted into one of said adjustment apertures at a desired predetermined length to secure said rear support leg in place.

14. A collapsible heavy duty aluminum snow gun mounting apparatus to mount a snow gun, comprising:
a snow gun holder with a back that includes a pair of vertical protrusions with an end with an aperture disposed on each said end of said vertical protrusion, wherein said apertures accommodate a bolt that is placed through said apertures;
a metal front leg with a top and a v-shape that includes a pair of legs with an end that are attached at said top of metal front leg with said snow gun holder welded on said top of front metal leg;
a pair of ball ski type wheels that are welded to said ends of said metal front leg;
a rear support leg with a v-shape, a top, two ends and a pair of legs that extends from said back of said snow gun holder and said metal front leg;
a plurality of adjustment apertures that are disposed on each said rear support leg to adjust and set one of a plurality of predetermined lengths of said pair of legs of said rear support leg;
a pair of friction brakes that are attached to each said end of said rear supports legs to secure said snow gun mounting apparatus to a ground surface; and
a pair of powder stoppers that are attached to each said end of said rear supports legs adjacent to said friction brakes to prevent said ends of said rear supports legs from sinking into a high amount of powder snow.

15. The apparatus according to claim 14, wherein said bolt is secured by a nut to secure said snow gun holder to said snow gun mounting apparatus.

16. The apparatus according to claim 15, wherein said nut is a Grade 8 bolt.

17. The apparatus according to claim 14, wherein said ball wheels are approximately in the range of 2 to 3 inches in radius.

18. The apparatus according to claim 14, wherein a lock pin is inserted into one of said adjustment apertures at a desired predetermined length to secure said rear support leg in place.

19. The apparatus according to claim 14, wherein said snow gun mounting apparatus is approximately 3.5 feet in height, 3 feet in width and 5 feet in length.

20. The apparatus according to claim 14, wherein said snow gun mounting apparatus weighs approximately 30 pounds.
